(19) United States
(12) Patent Application Publication
(10) Pub. No.: US 2026/0099641 A1
(43) Pub. Date: Apr. 9, 2026

(54) ONLINE CALIBRATION OF POWER SYSTEM MODEL USING TIME SERIES MEASUREMENT DATA

(71) Applicant: Siemens Corporation, Washington, DC (US)

(72) Inventors: Xiaofan Wu, Princeton, NJ (US); Murat Kaan Erdal, Princeton, NJ (US); Suat Gumussoy, Princeton, NJ (US); Ulrich Muenz, Princeton, NJ (US)

(73) Assignee: Siemens Corporation, Washington, DC (US)

(21) Appl. No.: 19/112,738

(22) PCT Filed: Jun. 13, 2023
(86) PCT No.: PCT/US2023/025107

§ 371 Date: Mar. 18, 2025

Related U.S. Application Data
(60) Provisional application No. 63/376,814, filed on Sep. 23, 2022.

(51) Int. Cl. G06F 30/20; G06F 113/04; H02J 13/12; H02J 103/30

(52) U.S. Cl. CPC G06F 30/20; H02J 13/12; G06F 2113/04; H02J 2103/30

(57) ABSTRACT

A computer-implemented method for online calibration of power system model against a power system includes iteratively approximating the power system model to a time-domain system model, at sequential optimization steps, as a function of parameter values of a set of system parameters. At each optimization step, an error is measured between a time series of a model output in response to the dynamic input signal and a time series of measurement signals obtained from the measurement devices defining an actual power system response to the dynamic input signal, summed over a number of discretized points in time with a defined sampling interval. A sequential optimizer is used to adjust parameter values of the calibration parameters and a system state to minimize the measured error, constrained by a discretization of the time-domain system model based on the sampling interval, to thereby determine optimal values of the calibration parameters.

### STATEMENT REGARDING FEDERALLY SPONSORED DEVELOPMENT

Development for this invention was supported in part by Subaward Agreement No: DE-AR0001062, awarded by Advanced Research Projects Agency-Energy (ARPA-E) that operates under the U.S. Department of Energy. Accordingly, the United States Government may have certain rights in this invention.

### TECHNICAL FIELD

The present disclosure relates to validation and calibration of power system models for increased reliability of power system models for operational decisions.

### BACKGROUND

Present day power systems have become dynamic and stochastic with the ever-increasing penetration of renewable energy, electrical vehicles and impacts from climate changes. Power system operators heavily rely on accurate power system models to determine appropriate planning and realtime control actions. Periodically validating stability models, for example, of generators, exciters, governors and power system stabilizers, is therefore of critical importance to power system operators.

Traditionally, power system model validation and parameter calibration have been implemented using staged testing. While effective and sufficiently accurate for establishing a power plant's models, this approach is very costly and labor intensive, because the generator being tested needs to be taken offline. As a low-cost alternative, model validation and parameter calibration can be implemented in an online mode without taking the generator offline.

A goal of model calibration practice is to reduce the discrepancy between the model and actual system behavior. Online model validation and parameter calibration involves injecting measurement signals, such as voltage magnitude and frequency/phase angle, into the power plant terminal bus during the dynamic simulation so one can compare a model's response to actual measurements obtained from the power system. This simulation method to validate the model is called ‘event playback’ and the injected measurements are called ‘play-in signals’.

Many currently known methods for state estimation and parameter calibration are based on using a Kalman filter or its variants. An example approach is described in the publication [1]: Renke Huang, Ruisheng Diao, Yuanyuan Li, Juan Sanchez-Gasca, Zhenyu Huang, Brian Thomas, Pavel Etingov et al. “Calibrating parameters of power system stability models using advanced ensemble Kalman filter.” IEEE Transactions on Power Systems 33, no. 3 (2017): 2895-2905. Other known approaches include non-linear curve fitting techniques, simultaneous perturbation stochastic approximation-based particle swarm optimization, feature based search, dynamic state-estimation-based generator parameter identification algorithm, rule-based approach, using Bayesian inference framework, deep reinforcement learning, among others.

State-of-the-art methods, such as that mentioned above, can be computationally intense, and may pose other challenges, such as existence of multiple solutions, poor convergence or precision, difficulty scaling to power systems having large number of generators, etc.

The International Patent Publication WO 2022231648 A1 disclosed a method for online calibration of a power system model using measurement data based on a H₂ optimization-based control framework to reduce input-output noise amplification in frequency domain.

### SUMMARY

Briefly, aspects of the present disclosure provide an improved technique for online calibration of a power system model against a power system, which can directly use a time series of electrical measurement data obtained from measurement devices on the field, while addressing at least some of the technical challenges mentioned above.

A first aspect of the disclosure provides a computer-implemented method for online calibration of a power system model against an actual power system. The power system comprises a number of active generator subsystems connected to a power network and a number of measurement devices installed in the power network to measure electrical quantities associated with each of the active generator subsystems. The method comprises obtaining measurement signals from the measurement devices as time series data that defines a response of the power system to a dynamic input signal. The method further comprises determining initial parameter values of a set of system parameters of the power system model. The method further comprises performing a series of iterations, where each iteration comprises executing a model approximator to generate a time-domain system model that at least locally approximates the power system model around a specified operating point, based on the initial parameter values and current parameter values of the set of system parameters, wherein a model output of the time-domain system model is a function of a system state and an input signal and the system state is a function of the input signal. Each iteration further comprises executing an objective evaluator to measure an error between a time series of the model output in response to the dynamic input signal and the time series of the measurement signals obtained from the measurement devices, summed over a number of discretized points in time with a defined sampling interval. Each iteration further comprises executing a sequential optimizer to adjust parameter values of at least a subset of the system parameters and the system state in a direction to minimize the measured error, wherein the sequential optimizer is constrained based on a discretization of the time-domain system model using the defined sampling interval. The power system model is thereby calibrated against the power system based on final values of the system parameters after the series of iterations.

Other aspects of the disclosure are directed to power systems implementing the above-described method and to computer program products having encoded thereon instructions that can configure a computing system to carry out the above-described method.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 is a schematic diagram of a power system including an online model calibration system according to an example embodiment.

FIG. 2 is a schematic diagram illustrating portion of a modeled power system that includes a generator subsystem.

FIG. 4 is a process flow diagram illustrating a model calibration method according to an exemplary embodiment.

FIG. 4 shows an example of a computing system that supports online calibration of a power system model according to aspects of the present disclosure.

### DETAILED DESCRIPTION

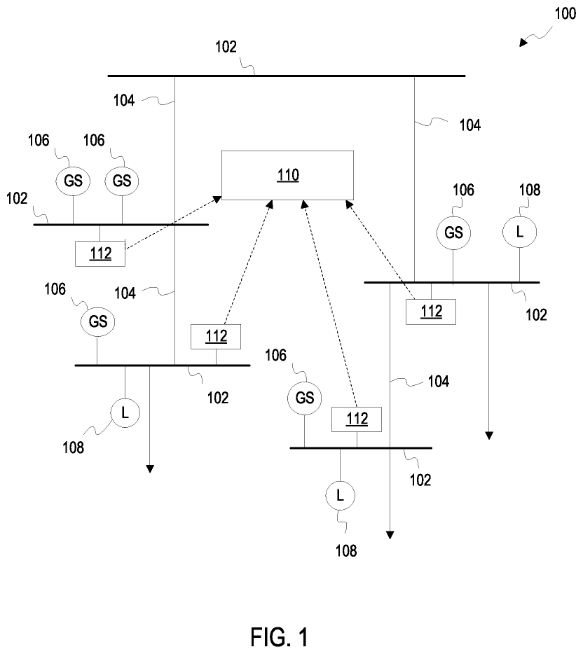

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present disclosure will be described with reference to exemplary non-limiting embodiments.

FIG. 1 illustrates an example of a power system 100 wherein aspects of the present disclosure may be implemented. The power system 100 includes a power network formed by a plurality of nodes or buses 102 connected by branches or power lines 104. The shown topology of the power network is illustrative and simplified. The disclosed methodology is not limited to any particular type of network topology. As shown, some of the nodes 102 may have one or more generator subsystems 106 and/or loads 108 connected to them. The generator subsystems 106 may include conventional power plants, but may also include distributed energy resources (DER) such as wind parks, photovoltaic panels, etc.

A power system operator, such as a utility company, may utilize a power system model of the power system 100 to determine appropriate planning and real time control actions. The power system model may form part of a digital twin of the power system 100. The power system model may be built, for example, using commercial software tools, such as PSS®E, developed by Siemens AG, PSLF® developed by General Electric Company, among many others. Integrity of the power system model can be key to reliable and economical delivery to power consumers, because long-term or midterm planning and operational decisions often reply on static and dynamic simulation executed using the power system model. One of the challenges associated with the model-based simulation is a discrepancy between the power system model output and actual power system behavior in response to the same input signal. Often, this discrepancy arises due to inaccuracies in the model parameters used in the power system model.

As shown in FIG. 1, the power system 100 includes an online model calibration system 110 to calibrate the power system model against the power system 100. The model calibration system 110 is configured to calibrate model parameters of the power system model using online measurement data from the power system 100 based on the methodology described herein. To that end, the model calibration system 110 may communicate with measurement devices 112 installed at various locations in the power network to measure electrical quantities, such as voltage, frequency, active power, reactive power, etc., associated with active (connected) generator subsystems 106. As shown, each individual measurement device 112 may be configured to carry out online measurements of the electrical quantities for one or multiple generator subsystems 106.

In one suitable implementation, one or more of the measurement devices 112 may comprise phasor measurement units. A phasor measurement unit (PMU) is a measurement device used to estimate the magnitude and phase angle of an electrical phasor quantity, such as voltage or current, in the electricity grid, with a common time source for synchronization. A typical commercial PMU can record measurements with high temporal resolution, up to about 120 samples per second. Such high-resolution data is very useful for calibration of power system models. The disclosed methodology is, however, not limited to a specific type of measurement device.

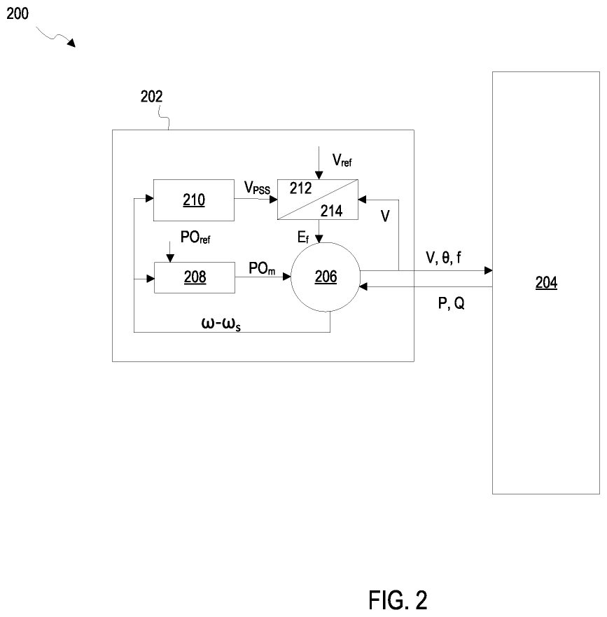

FIG. 2 illustrates portion of a modeled power system 200 showing in detail a modeled internal structure of a generator subsystem 202 connected to a power network 204. It is to be noted that the described modeling is merely an example and not meant to be limiting. A generator subsystem may comprise a generator and one or more controllers. In the shown example, the generator subsystem includes a synchronous generator 206 and controllers that include a governor 208, a power system stabilizer 210, an exciter 212 and an automatic voltage stabilizer 214. A detailed description of the modelling is available in the publication [2]: Amer Mešanović, Ulrich Münz, Joachim Bamberger, and Rolf Findeisen. “Controller tuning for the improvement of dynamic security in power systems.” In 2018 IEEE PES Innovative Smart Grid Technologies Conference Europe (ISGT-Europe), pp. 1-6. IEEE, 2018.

Briefly described, the governor 208 controls the mechanical power output POₘ of the prime mover (e.g., a turbine) into the generator 206 based on the angular velocity of the generator 206. The power system stabilizer 210 receives the deviation from nominal frequency ω-ωₛ as input to produce an output V_{PSS} that is configured to improve the small signal stability of the generator subsystem 202. The inputs to the exciter 212 are the reference voltage V_{ref}, the generator terminal voltage V and the input V_{PSS} from the power system stabilizer 210. The output of the exciter 212 is a field winding voltage E_{f}. The automatic voltage regulator 214 controls the field winding voltage E_{f} produced by the exciter 212 to regulate the terminal voltage V of the generator 206. The measurable quantities include the terminal voltage V, angle θ of the voltage phasor, frequency f, active power P and reactive power Q.

The model parameters of the power system model may include a set of controller parameters, such as gains, damping coefficients, time constants, etc. associated with the governor 208, power system stabilizer 210, exciter 212 and automatic voltage regulator 214 of various generator subsystems, for example, as identified in the publication [2]. The model parameters may additionally include physical parameters associated the generator subsystems, such as parameters indicative of size, inertia and design (e.g., number of generator poles, number of turns in winding, and so forth) of components such as turbine, shaft, generator, etc. The set of controller parameters and physical parameters are collectively referred to herein as “system parameters”.

The power system model of the power system 100 may be initially established, for example, from data obtained from staged testing (among other methods), in which engineers may run certain tests on individual generator subsystems 106 (e.g., power plants) to determine the values of system parameters that mathematically characterize the behavior of the power system 100. These values can then be used in the creation of the power system model. The power system model may give an accurate representation of the behavior of generator subsystems 106 as they interact with the power network. However, the originally used values of the system parameters may change as conditions in the power plants change, for example, when equipment is added or replaced. It is desirable, and often required, to keep the power system model current by periodic validation and calibration.

The disclosed methodology provides a technique for online calibration of system parameters of a power system model, that can include controller parameters and/or physical parameters of the modeled power system, typically both, based on measurement data. The disclosed methodology involves obtaining measurement signals from the measurement devices 112 as time series data that defines a response of the power system 100 to a dynamic input signal. The disclosed methodology also involves obtaining initial or original set of parameter values of the system parameters, which may include, for example, parameter values currently in use by a power system operator, such as a utility company, in their power system model. The parameter values are then optimized over a series of iterations by performing, at each iteration: using a model approximator to generate a time-domain system model that approximates the power system model at least locally around a specified operating point, using an objective evaluator to measure an error between a time series of a model output of the time-domain system model and a time series of the measurement signals from the measurement devices in response to the same dynamic input signal, and using a sequential optimizer to adjust or tune the parameter values of at least a subset of the system parameters as well as the system state in a direction to minimize the measured error. After the series of iterations, the final parameter values of the system parameters are transferred to the power system model to calibrate the power system model against the power system.

A distinguishing feature of the disclosed methodology is that it can directly use time series measurement data from the measurement devices, without requiring pre-processing or transformation of the measurement signals (e.g., to frequency domain) and computation of transfer functions, which can be challenging for power system models of large power systems. The disclosed methodology allows a calibration of a large number of system parameters simultaneously with a high degree of computational efficiency.

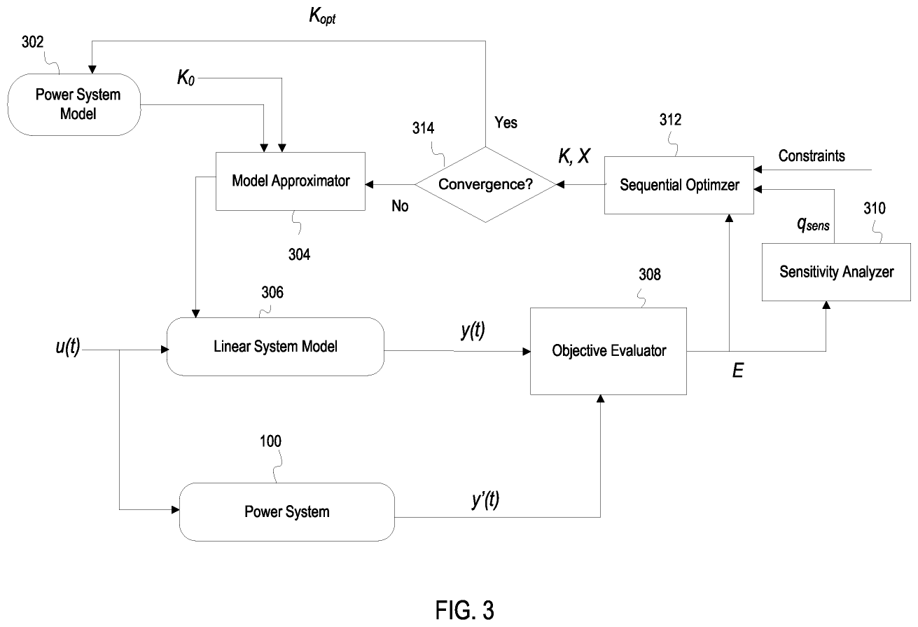

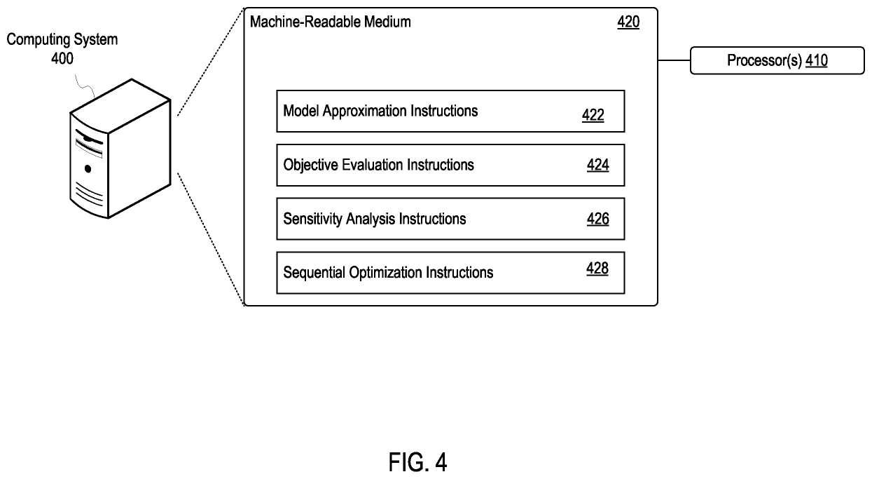

FIG. 3 illustrates a non-limiting example embodiment of a method executed by a model calibration system, such as the model calibration system 110, to calibrate a power system model 302 against a power system 100. The various engines described herein, such as the model approximator 304, the objective evaluator 308, the sensitivity analyzer 310 and the sequential optimizer 312, including components thereof, may be implemented by a computing system in various ways, for example, as hardware and programming. The programming for the engines 304, 308, 310 and 312 may take the form of processor-executable instructions stored on non-transitory machine-readable storage mediums and the hardware for the engines may include processors to execute those instructions. An example of a computing system for implementing the described engines is illustrated below referring to FIG. 4.

Referring to FIG. 3, the power system model 302 may include a non-linear system model describing the power system 100. In some embodiments, for model calibration, the existing commercial power system model used by a power system operator (e.g., provided as a model in PSS®E) may be converted to a different format suitable for carrying out the disclosed methodology. For example, the power system model 302 may be derived as an electro-magnetic-transient (EMT) model of the power system 100 in a Simulink® environment (e.g., SimPowerSystems®). The nonlinear power system model 302 may be generally represented as:

$$\dot{x} = f ( x , u , K ) , \qquad ( 1 a )$$

$$0 = h ( x , u , K ) , \qquad ( 1 b )$$

where x denotes a system state (e.g., combined power plant/generator states), u denotes an input signal including all reference values, loads and disturbances, f describes power system dynamics, K is a vector representing the set of system parameters to be calibrated, and h represents power flow equations of the power system model 302.

The optimization process starts by initializing the system parameters with initial parameter values K₀, for example, utilizing existing parameter values used by the power system operator. At each iteration r of the optimization, the model approximator 304 is executed to generate a time-domain linear system model 306 that approximates the power system model 302 at least locally around a specified operating point. In other embodiments, the approximated system model may be mildly non-linear (e.g., linear over a practical range) or may be non-linear. The specified operating point around which model is linearized may be chosen as one that defines a steady state response of the power system 100. The time-domain linear system model 306 is generated using the initial parameter values K₀ as well as the current parameter values K of the set of system parameters for the iteration r. The time-domain linear system model 306 is defined such that a model output y of the time-domain linear system model 306 is a linear function of the system state x and the input signal u, and the system state x is a linear function of the input signal u (in this case, a linear ordinary differential equation). The time-domain linear system model 306 may be represented in continuous time t as:

$$\frac{dx ( t )}{dt} = A ( K , {K}_{0} ) x ( t ) + B ( K , {K}_{0} ) u ( t ) , \qquad ( 2 a )$$

$$y ( t ) = C ( {K}_{0} ) x ( t ) + D ( {K}_{0} ) u ( t ) , \qquad ( 2 b )$$

where y is the model output signal (e.g., including voltage, frequency, active power, reactive power, etc.), and A, B, C and D are linear function coefficients (e.g., comprising matrices).

At each iteration r, a time series of a model output y(t) of the time-domain linear system model 306 is obtained for a dynamic input signal u(t). The dynamic input signal u(t) may comprise one or more of: reference values, loads and disturbances. The time series of the model output y(t) may be generated directly using the relationship in equation (2b). The same dynamic input signal u(t) may be used for every iteration. However, the time series of the model output y(t) may change with every iteration as the system state x(t) is adjusted by optimization engine at each iteration.

The objective evaluator 308 is used at each iteration r to measure an error E between the time series of the model output y(t) and the time series of the measurement signals P(t) that define a response of the power system 100 to the same dynamic input signal u(t), summed over a number of discretized points in time with a defined sampling interval T. The model output y(t) and the measurement signals P(t) may be mapped to a multi-dimensional output space. The output space can be defined by electrical quantities such as frequency, voltage, active power and reactive power, etc.

According to a disclosed embodiment, the error E is measured at each iteration as an [symbol] ₂ norm between the time series of the model output y(t) and the time series of the measurement signals y′(t) for individual active generator subsystems i, summed over the number m of active generator subsystems. The error E may be measured as:

$$E = {\sum }_{i = 1}^{m} {\sum }_{j = 1}^{N} {( {y}_{i}^{′} ( jT ) - {y}_{i} ( jT ) )}^{2} , \qquad ( 3 )$$

where T is the sampling interval of the measurement data, jT denotes discretized points in time, and N is the number of time steps. In other embodiments, another suitable norm, such as a [symbol] ₁ norm, based on absolute difference between the model output and the measurement signals, may be used as a measure for the error E.

To further improve computational efficiency, in some embodiments, a sensitivity analysis may be carried out to select a subset of highly sensitive system parameters, out of the set of system parameters, for optimization by the sequential optimizer 312. Sensitivity analysis can ensure that the optimization engine focuses on the parameters which have a higher sensitivity measure. Optimization complexity can thus be reduced such that the optimization algorithm converges to the optimal parameter values more efficiently. Having less parameters to tune makes the underlying problem easier to fit and increases its scalability.

While a number of different techniques can be used for sensitivity analysis, including those currently known or available, the disclosed methodology is distinguished from the known techniques by incorporating a sensitivity analyzer 310 inside the optimization loop. The sensitivity analyzer 310 may be executed at each iteration r to select a subset of the system parameters to be adjusted by the sequential optimizer 312 for that iteration, keeping the remaining system parameters in the set of system parameters fixed.

According to a disclosed embodiment, the sensitivity analyzer 310 may select the subset of the system parameters at each iteration by measuring a derivative of the error E with respect to each system parameter in the set of system parameters, and selecting a predefined number n of system parameters which provide the largest derivatives. The above can be mathematically represented as:

$${q}_{s e n s} = arg max ( ‖ \frac{dE ( K , X )}{dK} {\vert}_{K = {K}_{r}} ‖ , n ) , \qquad ( 4 )$$

where qₛₑₙₛ denotes indices of the selected system parameters to be optimized, n is the number of system parameters to be optimized, Kr denotes current parameter values of the set of system parameters at iteration r, and X is a stacked version of all states x(jT) for j=1, 2, . . . , N. Note that the relationship between X and K can be established based on a discretization of the time-domain linear system mode, for example as described in equations (5b) and (6).

Using a sensitivity analyzer 310 within the optimization loop can ensure that system parameters that have diminishing impact on the measured error over a number of iterations can be dynamically replaced by other system parameters that have relatively more impact. A faster convergence can be achieved by optimizing only those system parameters that have a higher sensitivity measure for an iteration. In other embodiments, the sensitivity analyzer 310 may be included outside the optimization loop, whereby the subset of the system parameters being optimized in every iteration remains fixed. In still other embodiments, e.g., when the number of system parameters to be optimized is low, the sensitivity analyzer 310 may be omitted.

The sequential optimizer 312 is executed at each iteration r to adjust or tune parameter values of the system parameters K as well as the system state X in a direction to minimize the error E. In the disclosed embodiment, sequential optimizer 312 is configured to tune, at each iteration r, only the parameter values of the system parameters selected by the sensitivity analyzer 310 for the iteration. The system state X being tuned at each iteration r includes all of the system states x(jT) for j=1, 2, . . . , N. The constraints for the optimization problem may be built based on a discretization of the time-domain linear system model. According to a disclosed embodiment, a bilinear transformation may be used to discretize the linear system model. The optimization problem may thus be formulated as follows:

$${min}_{K , X} E \qquad ( 5 a )$$

$$s . t . {A}^{-} ( K , {K}_{0} ) x ( ( j + 1 ) T ) = {A}^{+} ( K , {K}_{0} ) x ( jT ) + \frac{T}{2} B ( K , {K}_{0} ) ( u ( jT ) + u ( ( j + 1 ) T ) ) , \qquad ( 5 b )$$

where equation (5b) defines the constraint built based on a bilinear transformation of the continuous time linear system model defined by equation (2a), where A⁻(K, K₀) and A⁺(K, K₀) are defined as:

$${A}^{-} ( K , {K}_{0} ) = I - \frac{T}{2} A ( K , {K}_{0} ) , {A}^{+} ( K , {K}_{0} ) = I + \frac{T}{2} A ( K , {K}_{0} ) \qquad ( 6 )$$

The sequential optimizer 312 may comprise an optimization engine configured to carry out sequential convex optimization to minimize the error E ( [symbol] ₂ norm) between the measurement signals and the model output based on the formulation described above. Examples of optimization engines suitable for the disclosed embodiments include reinforcement learning (RL) algorithms, genetic algorithms, gradient free optimization algorithms, non-linear least square algorithms, or linear programming algorithms (if the error E is measured as a [symbol] ₁ norm), among others.

The adjusted parameter values K and the system state X may then form a new design point for the model approximator 304 to generate a linear system model 306, based on the power system model 302, for the next iteration r=r+1. Optimal values of the system parameters K may be obtained by iteratively executing the above-described steps, until a convergence criterion is satisfied (decision block 314). The convergence criterion may be based, for example, on a threshold difference between the parameter values K between consecutive iterations. Alternately, the convergence criterion may specify the number of optimization steps to be executed. Upon convergence, the final parameter values Kₒₚₜ of the model calibration parameters may be transferred to the power system model 302 (e.g., eq. (1a) and (1b)), to thereby calibrate the power system model 302 against the power system 100.

In a further aspect, the power system model 302, which may be calibrated by any of the disclosed embodiments, may be used to control the power system 100. The calibrated power system model 302 may be used to run simulations to predict a response of the power system 100 to one or multiple input scenarios (e.g., including grid disturbances, power network contingencies, etc.). Simulations using the calibrated power system model may be used, for example, for setting power system operating limits, based on which one or more controllers of the generator subsystems 106 may be controlled using control signals (e.g. from a centralized grid control system) to generate real time control actions. The control actions can include controlling one or more electrical quantities assorted with the generator subsystems 106, such terminal voltage, frequency, active power, etc. As examples, the control actions may be configured to maintain reliable operation of the various generator subsystems 106 under uncertainties in load and/or infeed power, to maintain dynamic security of the power system 100 in the event of a dropout of a power plant, and so forth.

FIG. 4 shows an example of a computing system 400 that supports online calibration of a power system model according to the present disclosure. The computing system 400 may form part of a model calibration system, such as the model calibration system 110. The computing system 400 includes at least one processor 410, which may take the form of a single or multiple processors. The processor(s) 410 may include a central processing unit (CPU), a graphics processing unit (GPU), a microprocessor, or any hardware device suitable for executing instructions stored on a memory comprising a machine-readable medium. The computing system 400 further includes a machine-readable medium 420. The machine-readable medium 420 may take the form of any non-transitory electronic, magnetic, optical, or other physical storage device that stores executable instructions, such as model approximation instructions 422, objective evaluation instructions 424, sensitivity analysis instructions 426 and sequential optimization instructions 428, as shown in FIG. 4. As such, the machine-readable medium 420 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 400 may execute instructions stored on the machine-readable medium 420 through the processor(s) 410. Executing the instructions (e.g., the model approximation instructions 422, the objective evaluation instructions 424, the sensitivity analysis instructions 426 and the sequential optimization instructions 428) may cause the computing system 400 to perform any of the technical features described herein, including according to any of the features of the model approximator 304, the objective evaluator 308, the sensitivity analyzer 310 and the sequential optimizer 312 described above.

The systems, methods, devices, and logic described above for the various engines, including the model approximator 304, the objective evaluator 308, the sensitivity analyzer 310 and the sequential optimizer 312, may be implemented in many different ways in many different combinations of hardware, logic, circuitry, and executable instructions stored on a machine-readable medium. For example, these engines may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the model approximator 304, the objective evaluator 308, the sensitivity analyzer 310 and the sequential optimizer 312. Computer readable program instructions described herein can be downloaded to respective computing/processing devices from a computer readable storage medium or to an external computer or external storage device via a network, for example, the Internet, a local area network, a wide area network and/or a wireless network.

The processing capability of the systems, devices, and engines described herein, including the model approximator 304, the objective evaluator 308, the sensitivity analyzer 310 and the sequential optimizer 312, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

The system and processes of the figures are not exclusive. Other systems, processes and menus may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the disclosure.

1. A computer-implemented method for online calibration of a power system model against a power system having a number of active generator subsystems connected to a power network and a number of measurement devices installed in the power network to measure electrical quantities associated with each of the active generator subsystems, the method comprising:
obtaining measurement signals from the measurement devices as time series data that defines a response of the power system to a dynamic input signal,
determining initial parameter values of a set of system parameters of the power system model,
performing, over a series of iterations:
executing a model approximator to generate a time-domain system model that at least locally approximates the power system model around a specified operating point, based on the initial parameter values and current parameter values of the set of system parameters, wherein a model output of the time-domain system model is a function of a system state and an input signal and wherein the system state is a function of the input signal,
executing an objective evaluator to measure an error between a time series of the model output in response to the dynamic input signal and the time series of the measurement signals obtained from the measurement devices, summed over a number of discretized points in time with a defined sampling interval,
executing a sequential optimizer to adjust parameter values of at least a subset of the system parameters and the system state in a direction to minimize the measured error, wherein the sequential optimizer is constrained based on a discretization of the time-domain system model using the defined sampling interval,
whereby, the power system model is calibrated against the power system based on final values of the system parameters after the series of iterations.

2. The method according to claim 1, further comprising, at each iteration, executing a sensitivity analyzer to select the subset of the system parameters to be adjusted by the sequential optimizer in that iteration keeping the remaining system parameters in the set of system parameters fixed.

3. The method according to claim 2, wherein the sensitivity analyzer selects the subset of the system parameters at each iteration by measuring a derivative of the error with respect to each system parameter in the set of system parameters and selecting a predefined number of system parameters which provide the largest derivatives.

4. The method according to claim 1, wherein the error is measured at each iteration as a norm between the time series of the model output and the time series of the measurement signals for individual active generator subsystems, summed over the number of active generator subsystems.

5. The method according to claim 1,
wherein the power system model comprises a non-linear system model,
wherein the time-domain system model generated by the model approximator at each iteration comprises a time-domain linear system model, and
wherein the sequential optimizer is constrained at each iteration by discretization of the time-domain linear system model using a bilinear transformation based on the defined sampling interval.

6. The method according to claim 1,
wherein each active generator subsystem of the power system comprises a generator and one or more controllers, and
wherein the system parameters comprise physical parameters of the generator subsystems and controller parameters of the controllers of the generator subsystems.

7. The method according to claim 1, wherein the dynamic input signal comprises one or more of: reference values, loads and disturbances.

8. The method according to claim 1, wherein the model output signal and the actual power system output signal are each mapped to a multi-dimensional output space, wherein the output space is defined by quantities selected from the group consisting of: frequency, voltage, active power and reactive power.

9. A non-transitory computer-readable storage medium including instructions that, when processed by a computing system, configure the computing system to perform the method according to claim 1.

10. A power system comprising:
one or more active generator subsystems connected to a power network,
a number of measurement devices installed in the power network to dynamically measure electrical quantities associated with each of the active generator subsystems, and
an online model calibration system for calibrating a power system model against the power system, the online model calibration system comprising:
one or more processors, and
a memory storing algorithmic modules executable by the one or more processors, the algorithmic modules comprising:
a model approximator configured to, at each iteration in a series of iterations, generate a time-domain system model that at least locally approximates the power system model around a specified operating point, based on initial parameter values and current parameter values of a set of system parameters, wherein a model output of the time-domain system model is a function of a system state and an input signal and the system state is a function of the input signal,
an objective evaluator configured to, at each iteration, to measure an error between a time series of the model output in response to the dynamic input signal and a time series of measurement signals obtained from the measurement devices that defines a response of the power system to the dynamic input signal, summed over a number of discretized points in time with a defined sampling interval, and
a sequential optimizer configured to, at each iteration, adjust parameter values of at least a subset of the system parameters and the system state in a direction to minimize the measured error, wherein the sequential optimizer is constrained based on a discretization of the time-domain system model using the defined sampling interval,
whereby, the power system model is calibrated against the power system based on final values of the system parameters after the series of iterations.
